(19) United States
(12) Patent Application Publication
(10) Pub. No.: US 2026/0021800 A1
(43) Pub. Date: Jan. 22, 2026

(54) APPARATUS AND METHODS FOR OPERATING A VEHICLE WITH AN ELECTRONIC STEERING SYSTEM

(71) Applicant: Ford Global Technologies, LLC, Dearborn, MI (US)

(72) Inventors: Sergio Codonesu, Aachen (DE); Oliver Nehls, Dusseldorf (DE); Alexander Ein Waldt, Koln (DE); Goetz-Philipp Wegner, Dortmund (DE)

(21) Appl. No.: 19/179,976

(22) Filed: Apr. 15, 2025

(30) Foreign Application Priority Data
Apr. 17, 2024 (DE) 102024110821.5

(51) Int. Cl. B60W 10/20

(52) U.S. Cl. CPC B60W 10/20; B60W 2510/10; B60W 2510/202

(57) ABSTRACT

This application relates generally to a procedure for operating a vehicle with an electronic steering system. A method for operating a vehicle with an electronic steering system includes controlling a road wheel actuator based on a detected steering wheel angle of a steering wheel operably coupled to a steering wheel actuator so that a steerable road wheel assumes a road wheel angle defined by the detected steering wheel angle in accordance with a transfer function, wherein the transfer function describes a dependence of the road wheel angle to the detected steering wheel angle, detecting a self-steering fault of the steering wheel actuator, and based on the detected self-steering fault estimating a steering wheel angle error, and triggering at least one compensatory measure, so that a road wheel angle error is at least reduced.

### RELATED APPLICATION

This patent claims priority from DE Patent Application No. 102024110821.5, which was filed on Apr. 17, 2024, and is hereby incorporated herein by reference in its entirety.

### FIELD OF THE DISCLOSURE

This disclosure relates generally to vehicles and, more particularly, to apparatus and methods procedure for operating a vehicle with an electronic steering system.

### BACKGROUND

Electronic steering systems are an emerging steering technology in which the mechanical connection between the steering wheel and the road wheel is eliminated and replaced by two actuators: a steering wheel actuator with feedback that generates feedback torque for the driver (e.g., on the steering wheel), and a road wheel actuator that control the road wheels to the desired position.

### BRIEF DESCRIPTION OF THE DRAWINGS

FIG. 1 depicts a simplified schematic representation of a vehicle with an electronic steering system according to an example.

FIG. 2 depicts a flowchart of an example method for operating a vehicle with an electronic steering system.

FIG. 3 depicts a simplified schematic representation of the wheel angle in connection with the method of FIG. 2.

FIG. 4 is a block diagram of an example processing platform including programmable circuitry structured to execute, instantiate, and/or perform the example machine readable instructions and/or perform the example operations of FIG. 2.

In general, the same reference numbers will be used throughout the drawing(s) and accompanying written description to refer to the same or like parts.

### SUMMARY

An example method for operating a vehicle with an electronic steering system includes controlling a road wheel actuator based on a detected steering wheel angle of a steering wheel operably coupled to a steering wheel actuator so that a steerable road wheel assumes a road wheel angle defined by the detected steering wheel angle in accordance with a transfer function, wherein the transfer function describes a dependence of the road wheel angle to the detected steering wheel angle, detecting a self-steering fault of the steering wheel actuator, and based on the detected self-steering fault estimating a steering wheel angle error, and triggering at least one compensatory measure, so that a road wheel angle error is at least reduced.

An example steering control system includes a steering wheel actuator, a steering wheel angle sensor to determine a position of the steering wheel actuator, a road wheel actuator, a road wheel angle sensor to determine an a position of the road wheel actuator, and a control device to determine a self-steering fault of the steering wheel actuator based on the position of the steering wheel actuator and the position of the road wheel actuator, determine a steering wheel actuator angle error, and implement at least one compensatory measure to reduce the steering wheel actuator angle error.

An example electronic steering system for a vehicle includes a steering wheel actuator, a steering wheel coupled to the steering wheel actuator, a road wheel actuator, a steerable road wheel coupled to the road wheel actuator, and a control device to determine a movement of the steering wheel and in response to the movement, reduce a road wheel actuator angle error.

### DETAILED DESCRIPTION

In steer-by-wire (SbW) systems, the desired road wheel angle (e.g., a pinion angle or rack and pinion travel) is determined or calculated based on a measured steering wheel angle and is electronically controlled. This calculation represents the simulated steering ratio between the steering wheel and the steerable road wheels and can be modified in such a way that the driver receives optimal feedback depending on the current vehicle operating characteristics, such as the vehicle speed. The desired feedback torque at the steering wheel is generated by the steering wheel actuator based on algorithms and vehicle signals. The steering wheel actuator is coupled to the steering wheel via the upper steering column.

Unintentional torque generation (e.g., self-steering) by the steering wheel actuator can result in an increase in steering wheel angular speed if the driver is unable to at least partially counteract the torque. Due to the much lower inertia and usually lower friction of the steering wheel actuator compared to a conventional electric power steering (EPS) system, the resulting increase in steering wheel angular speed is greater for the same torque. For example, driving situations can occur in which the driver loosely holds the steering wheel, or even has his hands away from the steering wheel (e.g., hands off). The change in the steering wheel angle resulting from the self-steering of the steering wheel actuator causes a change in the steering wheel angle input and causes unintentional steering of the steerable road wheels.

Previous approaches aim to reduce a feedback signal to the steering wheel actuator within a predefined time period or to interrupt the signal transmission (DE 102016009684 A1). Alternatively, the driver's request for steering the vehicle communicated in the signal transmission is only included in the transfer function to determine the steering movement of the wheels in accordance with a reduced amount. Similarly, DE 102019135047 A1 discloses an electronic steering system that includes a synchronization monitoring device. A synchronization of the offset between the steering command according to the steering wheel movement and the road wheel actuator can be considered to reduce the influence of unintentional driver input because of a fault in the steering wheel actuator. In addition, U.S. Pat. No. 11,780,493 B2 discloses that a maximum speed is reduced because of error detection. However, such known approaches only concern the downstream consequences of unintentional steering wheel movement based on estimates. In other words, these approaches do not address the task of compensating for the immediate effects of unintentional steering wheel movement.

There is therefore a need to eliminate or at least reduce the disadvantages of known methods of operating a vehicle with an electronic steering system and electronic steering systems. There is a need to develop an electronic steering system in such a way that the functionality and comfort of the electronic steering system can be better guaranteed in the case of self-steering of the steering wheel actuator than with previous approaches.

Examples disclosed herein eliminate or reduce the disadvantages of known methods of operating a vehicle with an electronic steering system to ensure functionality and comfort of the system. According to one aspect, some examples of the disclosure relate to a method of operating a vehicle with an electronic steering system. The electronic steering system may include at least one steering wheel actuator, a steering wheel coupled to the steering wheel actuator, a road wheel actuator, a steerable road wheel coupled to the road wheel actuator and a control device (e.g., electronic control unit (ECU)). The control device is at least coupled with the steering wheel actuator and the road wheel actuator. The control device is configured to control the road wheel actuator depending on a detected steering wheel angle of the steering wheel in such a way that the steerable road wheel assumes a road wheel angle defined by the detected steering wheel angle according to a transfer function. The control device is also configured to detect erroneous self-steering of the steering wheel actuator. The transfer function describes a dependence of the road wheel angle on the detected steering wheel angle.

As a result of a detection of the erroneous self-steering, the method (e.g., procedure) includes at least the following operations. A steering wheel angle error based on the erroneous self-steering of the steering wheel actuator is estimated by the control device. At least one compensatory measure is triggered or performed by the control device, so that the road wheel angle error is reduced or eliminated.

In accordance with the teachings herein, the effects of erroneous self-steering of the steering wheel actuator can be indirectly compensated for by changing the transfer function and can be mitigated or substantially eliminated. The compensatory measure is made possible by estimating the extent to which the erroneous self-steering of the steering wheel actuator causes a change in the angle of the vehicle's steerable road wheel. While previous approaches only counteract the effects of erroneous self-steering by adjusting the feedback to the driver or by adjusting parameters regarding the retroactive control of the road wheel actuator (e.g., ignore the resulting change in steering wheel angle), the present method pursues a more direct approach by directly modifying the control of the road wheel actuator. In this way, the effects of erroneous self-steering can be reduced or substantially eliminated. As a result, the vehicle is brought back to the desired movement trajectory faster than before, according to the driver's steering input. As a result, deviations caused by the erroneous self-steering can be compensated for more quickly. In other words, a lower deviation from the steering wheel can be substantially guaranteed in the event of erroneous self-steering of the steering wheel actuator. This increases comfort for the driver.

According to one aspect, some examples of the disclosure relate to an electronic steering system for a vehicle. The electronic steering system includes at least one steering wheel actuator, a steering wheel coupled to the steering wheel actuator, a road wheel actuator, a steerable road wheel coupled to the road wheel actuator and a control device including a control device. The control device is at least coupled with the steering wheel actuator and the road wheel actuator.

The control device is configured to control the road wheel actuator depending on a detected steering wheel angle in such a way that the steerable road wheel takes up a road wheel angle defined by the detected steering wheel angle according to a transfer function. The transfer function describes a dependence of the road wheel angle on the detected steering wheel angle. In turn, the control device is to detect erroneous self-steering of the steering wheel actuator and estimate a change in the steering wheel angle based on the erroneous self-steering of the steering wheel actuator. Further, the control device is configured to trigger at least one compensatory measure so that the road wheel angle error based on the estimated steering wheel angle error is reduced or substantially eliminated. The benefits achieved by the method described herein are also achieved in a corresponding manner by the electronic steering system.

The steering wheel actuator does not necessarily have to be directly coupled to the steering wheel. For example, the steering wheel actuator can also be coupled to a steering wheel column to which the steering wheel is attached. Likewise, the road wheel actuator does not have to be directly coupled with the vehicle's steerable road wheel. For example, the road wheel actuator can be coupled to a steering rack of the electronic steering system, which in turn is coupled to the steerable road wheel.

The erroneous self-steering of the steering wheel actuator can be triggered, for example, by a fault of the steering wheel actuator. The control device is configured as a common control device of the entire electronic steering system. Additionally, or alternatively, different control devices may also be provided, to interact with the steering wheel actuator and the road wheel actuator.

The transfer function represents the coupling of the steering wheel for the purpose of a steering input by the driver of the vehicle and the steerable road wheels of the vehicle. The transfer function enables the appropriate conversion of the steering input of the driver of the vehicle into a desired guidance of the vehicle. In addition, information about the current driving situation or road information can be made available to the driver via torque feedback to the driver at the steering wheel. This torque feedback can be determined based on various information such as steering wheel angle, road wheel angle, vehicle speed and/or steering force of the road wheel actuator.

Erroneous self-steering leads to an unintended movement of the steering wheel. This unintended movement of the steering wheel causes a change in the road wheel angle of the vehicle's steerable road wheels. In the present case, an error in road wheel angle is estimated and at least reduced by the control device of the electronic steering system.

In addition to the control device, the actuators may include actuator control devices that are configured to receive control signals that define a desired movement of the mechanical components (e.g., the steering wheel, steering column, or gear steering rack) to be caused by the respective actuator. The actuator control devices may be configured to control the respective actuator based on the actuator employed by the electronic steering system control device. Each actuator includes an electric motor to move the mechanical component coupled to the actuator. To cause the mechanical component to move, windings of the electric motor, for example, can be subjected to appropriate phase voltages. The control of the phase voltages in terms of timing and amplitude can then be performed by the actuator control devices based on the actuator signal received by the control device. Alternatively, the control device can also be configured to control the electric motors directly (i.e., based on the actuating signal), corresponding phase voltages can be provided immediately, for example by an inverter.

In some examples, an actuator signal is generated from the control device to the road wheel actuator based on the compensatory measure, so that the road wheel angle error based on the estimated steering wheel angle error estimated with respect to the erroneous self-steering is reduced or substantially eliminated. In this respect, a control signal is issued to the road wheel actuator that is adapted to the original configuration, so that the transverse or lateral guidance of the vehicle corresponds advantageously more precisely to the steering input provided by the driver.

In some examples, the compensatory measure includes at least a determination of the road wheel angle error based on the estimated steering wheel angle error by the control device, considering an original transfer function. This means that the control function, using the original transfer function, can determine how the steering wheel angle error caused by erroneous self-steering affects the road wheel angle error when the vehicle is laterally guided. As a result, the information base for further compensatory measures can be broadened, for example to make appropriate corrections to the vehicle's lateral guidance.

In some examples, the control device expresses the road wheel angle error based on the erroneous self-steering in terms of the transfer function or by a respective operating point of the transfer function. The transfer function describes the non-linear dependence of the road wheel angle on the steering input, on the measured steering wheel angle. Therefore, the transfer function generally includes a non-linear curve. In general, characteristic curves or characteristic curve fields are used depending on the operating point for the correct description of the relationship between the road wheel angle and the steering wheel angle. The transfer function applicable to the respective operating configuration (e.g., operating point) is considered to determine the road wheel angle error based on the steering wheel angle error caused by the erroneous self-steering. From a mathematical point of view, division or multiplication can be used, depending on the definition of the transfer function. This is because the product or the ratio of the transfer function and the steering wheel angle error affects the road wheel angle error. This makes it possible to consider different electronic steering systems with different transfer functions, for example when the dimensions of corresponding components such as the rack, the steerable road wheels or generally the characteristics of the vehicle vary. In other words, the steering wheel angle error is related to the specific electronic steering system for a given vehicle. By considering different transfer functions for different electronic steering systems or vehicles, the method can be applied to many different electronic steering systems.

In some examples, the electronic steering system can include at least a steering wheel sensor that is configured to detect a position and/or movement of the steering wheel or a component coupled to it (e.g., a steering column). For example, the steering wheel sensor may be configured to detect a steering wheel angular speed. In some examples, the steering wheel sensor can be part of the steering wheel actuator or be coupled thereto. Alternatively, the steering wheel sensor can also be coupled to the steering wheel separately from the steering wheel actuator.

In some examples, the control device considers a diagnostic time interval of the control device when estimating the steering wheel angle error based on the erroneous self-steering. This allows the compensation measure to be adapted to the diagnostic time interval as required. The diagnostic time interval of the control device describes the time interval between the diagnostic start time of the occurrence of the error (e.g., erroneous self-steering) and the diagnostic end point at which the control device has determined and triggered the measures (e.g., compensatory measures) to be taken due to the erroneous self-steering. The steering wheel angular speed can be recorded using the steering wheel sensor, for example.

In some examples, the diagnostic time interval is predefined and constant. Alternatively, the diagnostic time interval can be determined by the control device based on the fact that a steering wheel angular speed at a diagnostic start time of the diagnostic time interval is zero degrees/s. At a diagnostic stop time of the diagnostic time interval, the steering wheel speed of the steering wheel will be different from zero. In addition, the steering wheel angular speed of the steering wheel is known at the end of the diagnosis because it is detected by the steering wheel sensor. The diagnostic time interval can be determined by assuming that the steering wheel speed was accelerated by the steering wheel actuator based on the maximum steering wheel angle acceleration at the end of the diagnostic time as part of the faulty self-steering wheel acceleration. From this, the duration of the diagnostic time interval can be determined.

In some examples, the diagnostic time interval can be determined by the control device based on the fact that a continuously averaged steering wheel angular speed is considered before the start time of diagnosis, so that it is possible to deviate from the assumption that the steering wheel speed of the steering wheel is 0 deg/s at a diagnostic start time of the diagnostic time interval. To do this, the control device can continuously determine an average value of the steering wheel angular speed. Because the erroneous self-steering causes a large change in the steering wheel angular speed, the average value of the steering wheel angular speed will deviate disproportionately from the previous values, whereby the deviation makes it possible to identify the start of the diagnosis. The diagnostic time interval is then obtained according to the previous approach by using the average value of the steering wheel angular speed determined before the start of the diagnosis.

In some examples, the control device can be coupled with a storage device in which values of the steering wheel angular speed and/or the motor torque of an electric motor of the steering wheel actuator are continuously stored. The start of the diagnosis can be determined on the basis of the stored values of the steering wheel speed by the fact that the erroneous self-steering causes a large change in the amount of the steering wheel angular speed and/or the motor torque of the electric motor of the steering wheel actuator, so that a large change can be found in the stored values of the steering wheel speed and/or the engine torque, which makes it possible to determine the start of the diagnosis. The diagnostic time interval is then calculated in accordance with the previous approaches.

In some examples, the diagnostic time interval can be determined by the control device based on a steering wheel speed difference of the steering wheel between a diagnostic start time and a diagnostic end time of the diagnostic time interval. The steering wheel speed difference is determined by the control device based on a non-linear function. Alternatively, the steering wheel angular speed difference is determined by the control device based on a maximum torque that can be applied to the steering wheel by the steering wheel actuator. The maximum torque that the steering wheel actuator can apply to the steering wheel determines how quickly the steering wheel speed could be reached at the end of diagnosis. This allows the duration of the diagnostic time interval to be determined.

In some examples, the steering wheel angular speed difference is determined by the control device based on a detected torque applied to the steering wheel by the steering wheel actuator. The detected torque applied by the steering wheel actuator to the steering wheel determines how quickly the steering wheel speed is reached at the end of diagnosis. This allows the duration of the diagnostic time interval to be determined. In some examples, the steering wheel speed difference is determined by the control device based on an estimated torque applied to the steering wheel by the steering wheel actuator. Torque can be estimated, for example, based on motor parameters of the steering wheel actuator, such as speed, phase voltages and phase currents. The estimated torque applied by the steering wheel actuator to the steering wheel determines how quickly the steering wheel speed is reached at the end of diagnostic time. This allows the duration of the diagnostic time interval to be determined.

The steering wheel angular speed will generally have a difference between the start time of diagnosis and the time of end of diagnosis. To be able to determine a generally variable diagnostic time interval based on the steering wheel angular speed difference, the steering wheel angular speed difference can be used. The present method makes it possible to consider different steering wheel angular speed differences so that the diagnostic time interval can be accurately estimated. The different approaches allow for a high degree of variability and a mutual examination of the method regarding the determination of the diagnostic time interval. This increases the reliability of the method compared to previous approaches.

The torque applied by the steering wheel actuator to the steering wheel can be determined, for example, by measured values from the steering wheel sensor, for example by the control device. For example, the actual torque output or the estimated torque output can be determined or estimated based on parameters of the steering wheel actuator's electric motor. Alternatively, the torque applied by the steering wheel actuator to the steering wheel can also be estimated by the control device, for example based on characteristic curves or maps stored in a memory device that is coupled to the control device.

In some examples, the maximum torque that can be applied from the steering wheel actuator to the steering wheel can be considered. Thus, various approaches are available to determine the actual steering wheel angular speed difference caused by the erroneous self-steering of the steering wheel actuator.

In some examples, measured values of the steering wheel angle and/or engine torque can also be stored in the memory device, from which the steering wheel angle speed can be determined indirectly, for example by the control device. The respective steering wheel angle can be detected using the steering wheel sensor, for example. The respective motor torque here refers to the torque caused by the electric motor at an output. For example, the motor torque can be determined by the control device based on parameters of the steering wheel actuator's electric motor. For example, corresponding voltage sensors or current sensors, as well as position sensors, can be coupled to the electric motor. Based on the respective sensors, phase voltages, phase currents or the relative position between a rotor and a stator of the electric motor can be detected and transmitted to the control device. The control device can then determine the torque caused by the electric motor based on the measured values received. The corresponding recorded parameters can be stored as memory values in the data memory that is coupled with the control device. This further increases the adaptability of the method.

In some examples, the memory values can be recorded continuously for periods of time that are longer than the diagnostic time interval. This ensures that, regardless of the length of the diagnostic time interval, there are sufficient memory values to be able to read out corresponding values for the steering wheel angle and/or the torque caused by the steering wheel actuator for times prior to the occurrence of the erroneous self-steering.

In some examples, the storage of the corresponding memory values in the data memory can only be triggered for defined operating conditions of the electronic steering system. For example, it may be necessary for the steering wheel angular speed or the torque caused by the electric motor of the steering wheel actuator to exceed or fall below appropriate thresholds. In this respect, the threshold values serve as triggers for the storage of the memory values. This avoids relatively large amounts of storage space being required for continuous storage of the memory values.

In some examples, the control device of the electronic steering system freezes or preserves the data memory (e.g., stops overwriting of data) and triggers a diagnosis of erroneous self-steering of the steering wheel actuator (i.e., if the control device is to estimate a change in the steering wheel angle based on erroneous self-steering). This prevents continuously recorded measured values regarding the steering wheel angle and/or the steering wheel speed and/or the torque output by the electric motor of the steering wheel actuator from overwriting old memory values of the data memory, provided that the data memory is a data memory whose entries are continuously overwritten (e.g., at least after a certain time interval).

In some examples, the control device is configured to determine the start time of diagnosis by the data recorder evaluating a steep increase in the torque output by the electric motor of the steering wheel actuator and/or a relatively large change in the steering wheel angle. The erroneous self-steering of the steering wheel actuator causes a sudden change in the steering wheel angle of the steering wheel, which is due to an increase in the torque output by the electric motor. For this reason, the start of the diagnosis can be determined precisely if the measured values stored in the data memory regarding the motor torque and the steering wheel angle are searched for irregularities.

In some examples, the steering wheel angle can be used by the control device at the start of the diagnosis to estimate the amount of unintentional steering wheel angle from the start of the erroneous self-steering (e.g., diagnostic start time) to the detection (e.g., diagnostic end time). This means that the steering wheel angle error, which is based on the erroneous self-steering of the steering wheel actuator, can be determined precisely. This also makes it possible to compensate for the effects caused by the erroneous self-steering with increased precision. In some examples, the steering wheel angle difference between the time of the start of the diagnosis and the time of the freezing of the data memory can be used to estimate the amount of the unintentional steering wheel angle. This is another approach to increasing precision in determining the effects of incorrect self-steering of the steering wheel actuator compared to previous approaches.

In some examples, the compensatory measure includes at least a change in the transfer function. In particular, the gear ratio function of the steering can be changed depending on the steering wheel angle detected. As a result of the changed gear ratio, the estimated steering wheel angle error results in a reduced or substantially eliminated amount of road wheel angle error compared to a non-changed gear ratio. The modified transfer function is more indirect than the non-modified (e.g., original) transfer function. In this way, the target value of the road wheel angle error to be determined by the changed transfer function can be weakened compared to the non-changed transfer function. In this way, the effects of the error in steering wheel angle caused by self-steering on the vehicle's transverse guidance can be directly reduced or eliminated.

As part of the compensatory measure, an offset angle caused by the original transfer function is reduced or substantially eliminated via the modified transfer function. The changed gear ratio function causes an offset of the road wheel angle compared to the non-changed gear ratio. This offset is at least partially compensated (e.g., reduced, or completely compensated for), based on the modified transfer function, which ensures the reduction (e.g., compensation) of the offset. In some examples, the offset angle can be reduced (e.g., compensated) over an offset time interval. The offset time interval begins with the change of the transfer function. Subsequently, the modified gear ratio function is adapted in such a way that the offset with respect to the non-changed gear ratio function is compensated for at least during the offset time interval, in a continuous manner, in relation to the road wheel angle error caused by the changed gear function. This ensures comfortable alignment so that sudden changes are avoided for the user.

In some examples, the compensatory measure includes at least a filtering measure of a steering wheel input of the steering wheel. The filtering measure allows an automatic and continuous influence on the steering wheel input of the steering wheel. For example, the steering wheel input of the steering wheel can be determined based on the detected steering wheel angle. The filtering measure can then be automatically applied to the detected steering wheel angle to mitigate the effects of the steering wheel input. In some examples, the filtering measure includes low pass filtering of the detected steering wheel angle, so that the steering wheel input of the steering wheel is smoothed regarding the effects on the vehicle's lateral guidance. This can reduce the size of the effects.

In some examples, the control device is also configured to control the steering wheel actuator, based on a detected road wheel angle, among other things, in such a way that the steering wheel actuator applies feedback torque to the steering wheel. In the case of steering wheel actuators that can provide torque again after fault isolation or can provide additional torque in parallel to erroneous torque, the following strategies can be considered to reduce the effects of erroneous self-steering after the fault has been detected.

In some examples, the compensatory measure can include, when the steering wheel actuator is controlled by the control device, an additional counter-torque to be applied by the steering wheel actuator, the steering wheel or a component coupled to it (e.g., the steering column) is considered, so that a steering wheel angular speed caused by the erroneous self-steering is at least reduced or the steering wheel movement is stopped. In some examples, the counter-torque is provided in pulsed form, which means with a characteristic curve having a generally high amplitude. The counter-torque is, thus, opposed to the torque of the steering wheel angle change caused by the erroneous self-steering. The counter-torque causes the incorrect movement of the steering wheel to be mitigated or substantially eliminated and therefore also ensures that the possible overreaction of the driver is lower. By reducing the steering wheel angular speed, the magnitude of the incorrect steering angle and, thus, the magnitude of the incorrect road wheel angle, the severity of the incorrect vehicle reaction is reduced. This also enables the driver to enhance the correction of the error and also reduces the deviation from the desired route. This prevents the driver of the vehicle from overreacting to erroneous self-steering due to the faulty torque feedback, therefore shortening the time it takes for the effects of the erroneous self-steering to be reduced. In other words, the driver can compensate for the incorrect vehicle reaction more quickly.

The control device may control the steering wheel actuator in such a way that the feedback torque applied by the steering wheel actuator to the steering wheel is increased after the erroneous self-steering has been detected and compared to the feedback torque of the non-faulty electronic steering system. Here, a characteristic curve of the feedback torque is used that has a larger amplitude range than the normal curve, but which has a smaller amplitude range than that of the characteristic curve that is used in the context of the pulsed counter-torque. This means that the steering wheel actuator is controlled by the control device in such a way that, compared to the default configuration of the electronic steering system, the driver is provided with a higher feedback torque after the erroneous self-steering is detected rather than the feedback torque being made available to the driver before the erroneous self-steering. As a result, the driver of the vehicle reacts with a lower steering input so that the effects of the erroneous self-steering can be mitigated more easily than without the compensation measure.

In some examples, the control device controls the steering wheel actuator in such a way that an additional dampening torque is considered when providing the feedback torque. This also leads to the driver reacting with smaller steering inputs, which makes it easier to mitigate erroneous self-steering than without these measures. This prevents the driver of the vehicle from overreacting to the erroneous self-steering due to the faulty torque feedback, thereby reducing the degree of the faulty vehicle reaction. The method makes it possible to determine the effects of erroneous self-steering and to compensate them directly so that only a reduced change in road wheel angle is affected, compared to the situation without the control. As a result, the offset of the course of the road wheel angle can be adjusted quicker than before to the desired course.

In some examples, the electronic steering system may include at least one road wheel sensor configured to detect a road wheel angle of a steerable road wheel or a component of the vehicle coupled to it. In some examples, road wheel sensors and/or steering wheel sensors can be coupled to the control device and transmit corresponding measured values to the control device. In some examples, the method is configured as a computer-implemented program or instructions. This means that the operations of the method can be carried out with the help of one or more data processing devices. A data processing device can trigger or execute the corresponding operations. For example, a data processing device of the control device can estimate the road wheel angle error based on the erroneous self-steering and output a corresponding actuator to the road wheel actuator in such a way that the estimated road wheel angle error is reduced or eliminated.

According to a further aspect, the disclosure also relates to a computer program, including commands which, when executed by a computer, cause the computer to execute the methods as described herein. The benefits achieved by the methods described herein are also achieved in a corresponding manner by the computer program.

According to an additional aspect, the disclosure also relates to a computer-readable storage medium, including instruction which, when executed by a computer, causes the computer to execute the methods as described herein. The advantages achieved by the methods described herein are also achieved in a corresponding way by the computer-readable storage medium.

According to an additional aspect, some examples of the disclosure also concern a vehicle with an electronic steering system. The benefits achieved by the methods described herein are also achieved in a corresponding manner by the vehicle.

For the purposes of disclosure, vehicles may include land vehicles, namely, inter alia, off-road, and on-road vehicles such as passenger cars, buses, lorries and other commercial vehicles. Vehicles can be manned or unmanned. Vehicles can be at least partially electrically driven, have an internal combustion engine and/or an electric motor serving as a propulsion system.

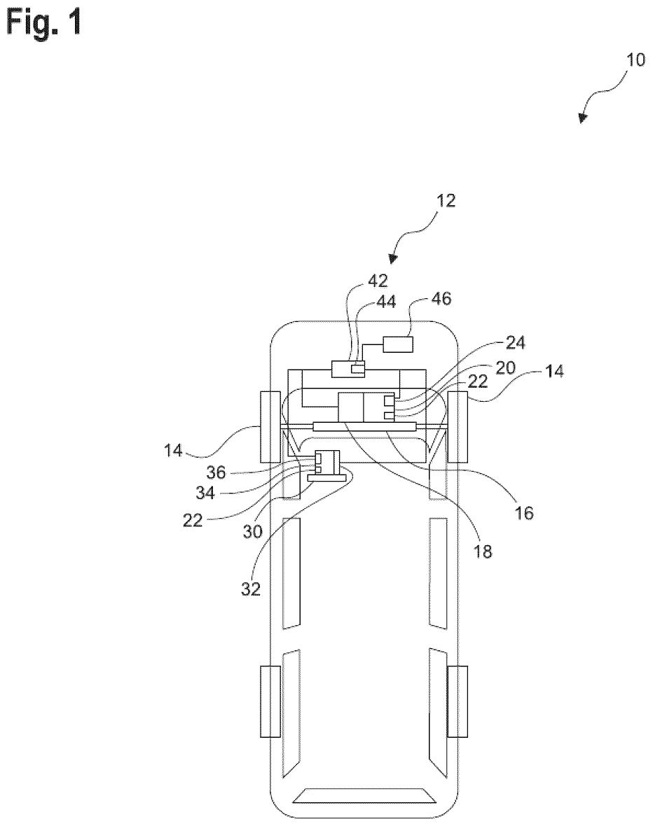

FIG. 1 depicts a simplified schematic representation of a vehicle 10 with an electronic steering system 12 according to an example. The vehicle 10 also includes steerable road wheels 14. The steerable road wheels 14 are coupled to a steering rack 16. The steering rack 16 can be moved from a reference position, for example a zero position, which causes a steering movement of the steerable road wheels 14. For example, the steerable road wheels 14 can be turned starting from a straight alignment of the vehicle 10 so that the vehicle 10 completes a turn. Even if only front-wheel steering is shown here, the vehicle 10 can of course also have rear-wheel steering instead or in addition. To move the steering rack 16, the electronic steering system 12 includes a road wheel actuator 18. In the present case, the road wheel actuator 18 is coupled with the steering rack 16. Alternatively, the road wheel actuator 18 can also be coupled with the steerable road wheels 14 in other ways to be able to influence their alignment (e.g., road wheel angle).

According to the illustrated example, the road wheel actuator 18 has an electric motor 20. The electric motor 20 includes at least one winding set 22, which includes a group of windings. Each winding set 22 is configured so that phase currents are configured in the underlying windings when supplied with supply signals, such as phase voltages, which can be used to drive a rotor of the electric motor 20. The rotor can then be coupled to the steering rack 16 and thus enable the movement of the steering rack 16. In general, the electric motor 20 can have more than one winding set 22. Typically, each winding set 22 is three-phase, so that the electric motor 20 is also three-phase. However, the electric motor 20 can also have more winding sets 22 and is then configured accordingly to six-phase or nine-phase or generally 3n-phase, with n greater than or equal to 1.

The road wheel actuator 18 further includes at least one road wheel sensor 24. In general, several road wheel sensors 24 can also be provided. The road wheel sensor 24 is configured to detect a position and/or a movement of the steerable road wheels 14 or a component coupled to it, in this case the steering rack 16. The detection of the position of the steering rack 16 allows the determination of the road wheel angle of the steerable road wheels 14. In this way, the orientation of the steerable road wheels 14 can be determined. Even though the road wheel sensor 24 is configured as part of the road wheel actuator 18, the road wheel sensors 24 can alternatively be arranged separately from the road wheel actuator 18 and be configured to detect a position and/or a movement of the steerable road wheels 14 of the vehicle or a component coupled to it. For example, the road wheel sensor 24 can be coupled separately from the road wheel actuator 18 to the steering rack 16.

The electronic steering system 12 of the vehicle 10 also includes a steering wheel 30. The steering wheel 30 allows a driver of the vehicle 10 to make steering input to the vehicle 10 to steer the vehicle 10 in a desired direction. A steering wheel actuator 32 of the electronic steering system 12 is coupled to the steering wheel 30. The steering wheel actuator 32 includes an electric motor 34. The electric motor 34 of the steering wheel actuator 32 also includes a winding set 22. The winding set 22 of the electric motor 34 of the steering wheel actuator 32 is coupled to the winding set 22 of the electric motor 20 of the road wheel actuator 18. This means that the winding set 22 of the electric motor 34 is configured to drive a rotor of the electric motor 34. As a result, the steering wheel 30 of the vehicle 10 can be subjected to a torque by the electric motor 34, which is a feedback torque for the driver, to give the driver feedback about the guidance of the vehicle 10. In the illustrated example, the electric motor 34 of the steering wheel actuator 32 includes a winding set 22 and is therefore three-phase but can also be configured in 3n-phase, with n greater than or equal to 1.

The electronic steering system 12 also includes a steering wheel sensor 36, which is part of the steering wheel actuator 32. In general, a plurality of steering wheel sensors 36 can also be provided. The steering wheel sensor 36 is configured to detect a driver's steering input based on a steering wheel angle of the steering wheel 30 or a component coupled to it (e.g., a steering column) with respect to a reference position. Alternatively, the steering wheel sensor 36 can also be separated from the steering wheel actuator 32 and still be configured to detect a position and/or movement of the steering wheel of the vehicle 10 or a component coupled to it.

In the illustrated example, the electronic steering system 12 of the vehicle 10 includes a control device 42. The control device 42 includes at least one data processing device 44 and is coupled to the road wheel actuator 18, the road wheel sensor 24, the steering wheel actuator 32 and the steering wheel sensor 36. In general, the electronic steering system 12 can also include separate control devices, each of which is assigned individually to the road wheel actuator 18 and the steering wheel actuator 32. In the illustrated example, however, the control functions are combined in the control device 42. In addition, the electronic steering system 12 includes at least one data memory 46, which is coupled with the control device 42. The data memory 46 is configured so that the corresponding parameters of the electronic steering system 12 can be stored within.

The control device 42 acts as a link between the road wheel actuator 18 and the steering wheel actuator 32 to cause a change in the road wheel angles of the steerable road wheels 14 of vehicle 10 depending on the driver's steering input via the steering wheel 30 and to provide torque feedback to the driver of vehicle 10 at the steering wheel 30 based on vehicle and/or actuator information.

In the illustrated example, the control device 42 is configured to detect faulty self-steering of the steering wheel 30 caused by the steering wheel actuator 32. For this purpose, the control device 42 can, for example, evaluate measurement data or information from the steering wheel actuator (e.g., current measurements) of the steering wheel sensor 36, which is configured to detect a steering wheel speed and/or a steering wheel angle of the steering wheel 30. In this respect, the control device 42 is configured to detect errors in the application of a feedback torque to the steering wheel 30 via the steering wheel actuator 32. In addition, the control device 42 is configured to store parameters of the electronic steering system 12 in the data memory 46.

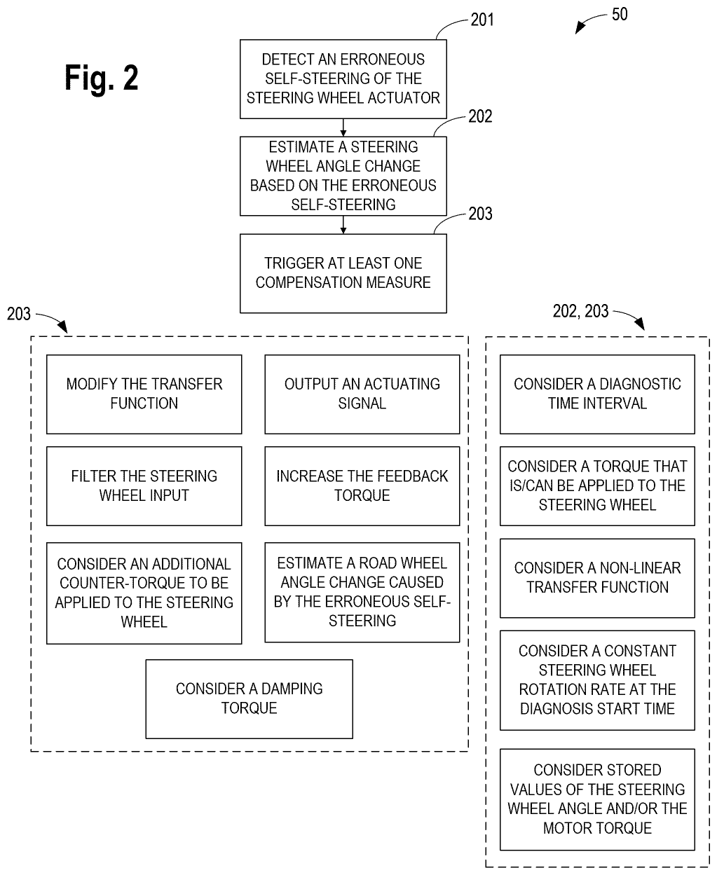

FIG. 2 depicts a flow diagram representation of a method 50 for operating a vehicle 10 with an electronic steering system 12. In operation 201, the control device 42 of the electronic steering system 12 detects erroneous self-steering of the steering wheel actuator 32. For example, this can be based on data collected by the steering wheel sensor 36 and transmitted to the control device 42.

In the subsequent operation 202, the control device 42 estimates a steering wheel angle error of the steering wheel 30 based on the erroneous self-steering of the steering wheel actuator 32. The steering wheel angle error can ultimately be used as a starting point to estimate the effects of incorrect self-steering.

Subsequently, the control device 42 triggers at least one compensatory measure in operation 203, so that the road wheel angle error caused by the erroneous self-steering on the estimated steering wheel angle error is reduced or eliminated. The compensation measure can be configured in different ways including combinations of individual measures. This means that the control of the road wheel actuator 18 is changed from an original control in the normal operating state of the electronic steering system 12. As a result, the steering wheel angle error of the steering wheel 30 based on the erroneous self-steering does not propagate into a road wheel angle change. This can beneficially mitigate the effects of the erroneous self-steering of the steering wheel actuator 32. Depending on the compensatory measure, the vehicle lateral control can be adapted to the desired trajectory more quickly than before.

In some examples, operation 203 can include generating a control signal from the control device 42 to the road wheel actuator 18, considering the compensatory measure, so that the road wheel angle change based on the steering wheel angle error estimated with respect to the erroneous self-steering is at least partially compensated. In this respect, an actuator signal is generated to the road wheel actuator 18 that is adapted to the non-changed configuration, so that the lateral control of the vehicle is advantageously less deviated from the driver's steering input.

In some examples, operation 203 can be modified so that the road wheel angle change of the steerable road wheels 14 of the vehicle 10 is estimated by the control device 42, which would be caused by the estimated steering wheel angle error of the erroneous self-steering. In doing so, the control device 42 considers an original (e.g., unmodified) transfer function that describes the dependence of the road wheel angle change of the steerable road wheels 14 on a change in the steering input based on the steering wheel 30 by the driver of vehicle 10. As a result, the information base for the compensation measure from the operation 203 can be broadened so that the compensation measure can be tailored to application specific needs.

In some examples, the control device 42 can relate the steering wheel angle error based on the erroneous self-steering through the transfer function. The transfer function generally includes a non-linear curve. Therefore, different transfer functions are considered for each vehicle application, for example in the form of characteristic curves or characteristic curve fields, depending on the operating point for the correct description of the dependency relationship between the road wheel angle and the steering wheel angle for the respective vehicle application. The transfer function applicable to the specific operating configuration (e.g., operating point) is considered to determine the road wheel angle change based on the steering wheel angle error caused by the erroneous self-steering. For example, division or multiplication can be used, depending on the definition of the transfer function. As a result, the effects of the erroneous self-steering of the steering wheel actuator 32 on the respective electronic steering system 12, the vehicle 10 and the respective vehicle application are more precisely normalized (e.g., adjusted). Because the transfer function describes the specific dependence for the respective electronic steering system 12, the effect of the change in the steering wheel angle caused by the erroneous self-steering of the steering wheel actuator 32 on the resulting change in the road wheel angle is related to the respective electronic steering system 12, the vehicle 10 and/or the respective vehicle application. In other words, the specific characteristics of the underlying electronic steering system 12, vehicle 10 and the vehicle application can be considered in terms of the effective coupling between the steering wheel 30 and the steerable road wheels 14.

Within operations 202 and/or 203, the control device 42 may consider a diagnostic time interval of the control device 42 when estimating the steering wheel angle error based on the erroneous self-steering and/or determining the necessary compensatory measure. For example, the diagnostic time interval can be predefined or variable. The diagnostic time interval describes the time interval required by the control device 42 to determine and trigger the corresponding measures measured at the time of detection of the erroneous self-steering.

A variable diagnostic time interval can be determined based on one or more procedural operations. The control device 42 can consider that there is a steering wheel speed difference of the steering wheel 30 between the start time of the diagnosis and the end time of the diagnosis time interval. The steering wheel speed difference is determined by the control device 42 based on a torque applied to the steering wheel 30 or a maximum torque that can be applied by the steering wheel actuator 32 to the steering wheel 30. The maximum torque that the steering wheel actuator 32 can exert is predetermined by the fixture parameters of the steering wheel actuator 32. The actual torque applied can be determined, for example, by sensors that detect the motor speed and/or phase voltages or others. Knowing the steering wheel 30 speed at the start of the diagnosis or the end of the diagnosis, the duration of the diagnostic time interval can then be determined. The steering wheel speed can be detected via a steering wheel sensor 36, for example.

Further, a non-linear function can be used by the control device 42 to determine the steering wheel speed difference.

Additionally, the variable diagnostic time interval can be determined by the control device 42 by assuming a constant steering wheel speed at the start of the diagnosis for example, a steering wheel speed of 0 deg/s. In other words, according to this approximation, it is assumed that the steering wheel 30 was in a static position at the time of the start of the diagnosis. For example, the length of the diagnostic time interval can be estimated based on the torque applied to the steering wheel 30 by the steering wheel actuator 32 or the maximum torque that can be applied, for example by considering the steering wheel speed at the end of the diagnosis.

The control device 42 can be further coupled with the storage device 46. In the storage device 46, memory values of the steering wheel angle and/or the steering wheel speed and/or the torque applied by the steering wheel actuator 32 to the steering wheel 30 can be stored continuously. As a result, the control device 42 can use the memory values of the memory device 46 to determine the diagnostic time interval. For example, a memory value of the steering wheel speed at a point in time corresponding to the start of the diagnosis can be considered. This memory value may have been determined, for example, based on readings from the steering wheel sensor 36, which detects the steering wheel angle, and may have been stored in the memory device 46. Alternatively, parameters of the electric motor 34 determined accordingly by the control device 42 can also be stored in the memory device 46, which can also be used to determine the steering wheel speed at the start of the diagnosis.

For example, the control device 42 can search for the corresponding entry in the memory device 46 according to the start of the diagnosis. Because the steering wheel angle and/or the steering wheel speed and/or torque at the start of the diagnosis are now known, the corresponding quantity can be determined regarding the end of the diagnosis. Based on the steering wheel speed difference, the torque applied by the electric motor 34 to the steering wheel 30 can be determined. For example, the change in steering wheel angle caused by the erroneous self-steering of the steering wheel actuator 32 can be determined.

The determination of the diagnostic start time by the control device 42 can be carried out by searching the memory values stored in the memory device 46 regarding the detected steering wheel angle and/or the recorded steering wheel speed and/or the torque output by the electric motor for large changes in amount (e.g., high gradients). This is because the erroneous self-steering causes a spontaneous, sudden movement of the steering wheel 30. This movement of the steering wheel 30 is because the electric motor 34 of the steering wheel actuator 32 outputs a sudden torque to the steering wheel 30, based on which a sudden change in steering wheel angle is affected. Therefore, the determination of the start of the diagnosis can be based on the identification of correspondingly high gradient values.

Mutual plausibility checks by the control device 42 can also be enabled. Accordingly, when estimating the error in the steering wheel angle caused by the erroneous self-steering, a diagnostic time interval is considered, which is used by the control device 42 to determine and trigger the corresponding measures measured at the time of detection of the erroneous self-steering. This allows both parameters of the control device 42, such as its computing power, and in some examples the characteristics of the steering wheel actuator 32, such as the torque applied, to be considered. As a result, it is easier to determine the extent to which a change in road wheel angle is caused by the erroneous self-steering of the steering wheel actuator 32.

In some examples, operation 203 can also include wherein the control device 42 changes the transfer function as a compensatory measure after detecting the erroneous self-steering of the steering wheel actuator 32. Compared to the non-modified transfer function, the modified transfer function results in a more indirect control of the road wheel angle change (i.e., the target value for vehicle lateral control), which is carried out on the driver's steering input using the steering wheel 30. This means that for the relationship between the road wheel angle change and the steering wheel angle error, the transfer function that correctly describes the electronic steering system 12 is no longer used, but a specifically adapted value of it. For example, the road wheel angle change can be smaller in the case of the same steering input based on the changed gear ratio function than is the case for the case of the non-changed gear ratio.

In some examples, an offset angle caused by the change of the original transfer function to the modified transfer function is at least partially reduced by the control device 42 as part of the compensatory measure. This avoids abrupt changes in the vehicle lateral control.

In some examples, the compensatory measure includes wherein the control device 42 applies a filtering measure to the steering wheel input of the steering wheel 30. This allows the measurement signal from the driver's steering wheel input to be directly influenced, which also causes a change in the behavior of the vehicle's transverse guidance.

For example, the filtering measure may provide for low pass filtering by the control device 42. This allows the effect of the steering wheel position of the steering wheel 30 to be amplitude-like, thus ensuring smoothing out the effects of the driver's steering wheel input on the vehicle's lateral guidance. Again, this leads to a more indirect effect of the steering wheel angle error on the corresponding road wheel angle change.

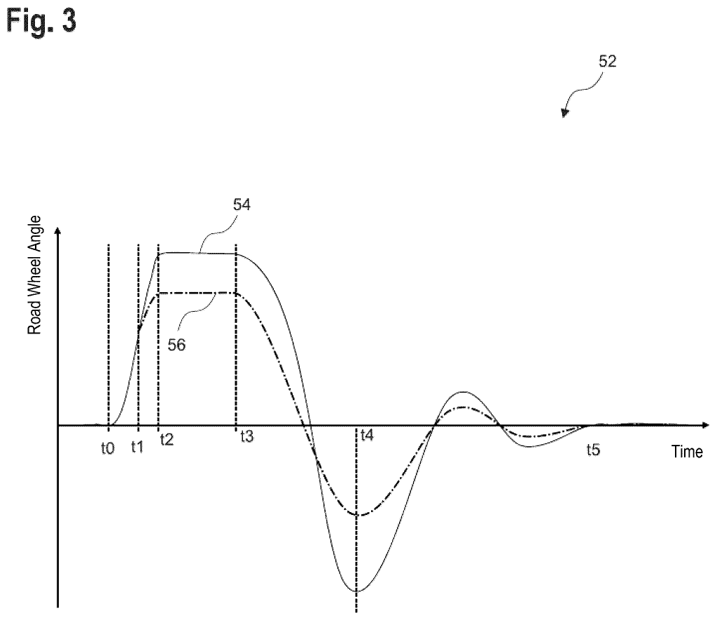

Operation 203 may also include wherein the control device 42 considers an additional counter-torque to be applied to the steering wheel 30 in the torque feedback for the driver at the steering wheel 30, which is affected by the steering wheel actuator 32. “Impulse-like” means that a relatively high counter-torque is applied, for example depending on the performance of the steering wheel actuator 32. For this purpose, a corresponding characteristic curve can be selected. The counter-torque is opposite to the torque of the error in steering wheel angle caused by the erroneous self-steering. By reducing the steering wheel rotation speed, the amplitude of the incorrect steering angle and thus the amplitude of the incorrect road wheel angle and thus the severity of the incorrect vehicle reaction is reduced. In addition, this ensures that the possible overreaction of the driver is less than without counter-torque. In general, the torque feedback gives the driver feedback regarding the lateral control of the vehicle 10. However, the faulty self-steering of the steering wheel actuator 32 causes high torque feedback, which the driver of the vehicle 10 wants to correct, but this typically leads to overcorrection by the driver (e.g., time t4 in FIG. 3). The impulse-like counter-torque considered by the control device 42 during the control of the steering wheel actuator 32 after the erroneous self-steering now has the effect that a force of the steering wheel opposite to the direction of error is made available to the driver and thus the necessary correction by the driver is smaller in terms of amount and, thus, the overcorrection by the driver can be reduced or completely prevented.

In some examples, operation 203 may include increasing the feedback torque by the control device 42 compared to the feedback torque in the normal state. Here, a characteristic curve of the feedback torque is used, which has a larger amplitude than the normal amplitude in terms of amount, but which has a smaller amplitude in terms of amount than the course of the characteristic curve that is used in the context of the impulse-like counter-momentum. Thus, a feedback torque applied by the steering wheel actuator 32 to the steering wheel 30 after the erroneous self-steering is detected is higher than a feedback torque made available to the driver before the erroneous self-steering. By increasing the feedback torque, the effects of a change in the road wheel angle are reduced in amount. For example, the road wheel angle can be detected using the road wheel sensor 24 and transmitted to the control device 42. As a result, the driver of vehicle 10 reacts with a lower steering requirement, so that the effects of the erroneous self-steering can be reduced more easily than without the compensation measure.

Alternatively, or additionally, an additional damping torque can be considered. The damping torque can be based on, for example, mechanical and/or electronically controlled damping. For example, mechanical friction or electrical resistance can be caused by, for example, short-circuiting the windings of the electric motor and/or by switching on an electrical resistance. In addition, an adapted control program can be used to control the steering wheel actuator, which results in higher damping. The damping torque is triggered by the control device 42 and, if necessary, also controlled. The damping torque causes the effects of the erroneous self-steering to result more slowly in a corresponding torque applied by the steering wheel actuator 32 to the steering wheel 30. This ensures an extended period for the driver to counteract torque feedback. As a result, the changes in torque feedback on the steering wheel 30 are less abrupt, allowing the driver of the vehicle 10 to counter steer more appropriately, resulting in reduced overcorrection by the driver. Consideration of damping torque also ensures redundancy in the form of passive torque feedback to the driver, for example if feedback torque can no longer be activated because no active feedback channel is available.

In this context, FIG. 3 shows a simplified schematic representation 52 of road wheel angle curves in connection with the method 50. The y-axis shows the change in the road wheel angle of the steerable road wheels 14 compared to the time on the x-axis. At 54, the course of the road wheel angle is shown without an adjustment of the gear ratio. In contrast, 56 denotes the course of the road wheel angle of the steerable road wheels 14, at which a transfer function changed at time t1 is applied by the control device 42.

Time t0 indicates the beginning of the erroneous self-steering of the steering wheel actuator 32. The control device 42 requires a certain time interval to detect erroneous self-steering, to determine and trigger the appropriate measures. Accordingly, the time to also refers to the time of the start of the diagnosis. At time t1, several corresponding compensatory measures are triggered by the control device 42. Thus, the time t1 is also the final time of diagnosis. The time interval between the time points t0 and t1 is thus the diagnostic time interval.

At time t1, the transfer function is changed by the control device 42 in such a way that only a more indirect reaction of the road wheel angle change to the steering wheel angle error is caused. As a result, the road wheel angle change based on the steering wheel angle error for course 56 is smaller in amount than would be the case for course 54 (e.g., non-changed gear ratio).

At time t2, the road wheel angle no longer changes, but remains constant, which is due to the reaction torque of the driver of vehicle 10. Since the curve 56 of the road wheel angle is smaller in amount than the unchanged curve 54, this means that the vehicle 10 more closely follows the original trajectory desired by the driver and has only a reduced deviation (e.g., distance) from it.

At time t3, the driver of vehicle 10 begins to correct the path of vehicle 10 by counter steering to return to the desired trajectory. In this phase, the change in the road wheel angle due to the counter-steering movement (e.g., due to the changed gear ratio) is smaller in amount than is the case for the course 54 with the original gear ratio. This results in less overcorrection of the effects of erroneous self-steering by the driver of vehicle 10 (e.g., time t4).

At time t5, the counter steering of the driver of vehicle 10 causes the curve 56 of the road wheel angle with the changed transfer function to be adjusted to the desired trajectory.

The different configurations of the compensation measure make it possible to reduce abrupt changes in the vehicle's lateral guidance and sudden changes in the road wheel angle.

All disclosed examples of method 50 lead to the identification and triggering of appropriate compensatory measures in the control device 42 to extend the periods guaranteed to the driver to counteract the unintentional steering movement and they lead to an immediate reduction of the effects of the erroneous self-steering of the steering wheel actuator 32. This provides a method 50 that increases operator comfort and makes it possible to reduce the influence of faulty self-steering more quickly than previous approaches.

Specific examples disclosed herein use circuits (e.g., one or more circuits) to implement standards, protocols, methods, or technologies disclosed here, to functionally couple two or more components, to generate information, to process information, to analyze information, to generate signals, to encode/decode signals, to convert signals, to transmit and/or receive signals, to control other devices, etc. Circuits of any kind can be used.

In some examples, a circuit such as the control device includes, but is not limited to, one or more data processing devices such as a processor (e.g., a microprocessor), a central processing unit (CPU), a digital signal processor (DSP), an application-specific integrated circuit (ASIC), a field-programmable gate array (FPGA), a system on a chip (SoC), or similar, or any combination thereof, and can contain discrete digital or analog devices circuit elements or electronics or combinations thereof. In some examples, circuits include hardware circuit implementations (e.g., implementations in analog circuits, implementations in digital circuits, and the like, and combinations thereof).

In some examples, circuits include combinations of circuits and computer program products with software or firmware instructions stored on one or more computer-readable memories that work together to cause a device to execute one or more of the protocols, procedures, or technologies described herein. In one example, circuit engineering includes circuits, such as microprocessors or parts of microprocessors, which require software, firmware, and the like to operate. In one example, the circuits include one or more processors or parts thereof and the associated software, firmware, hardware, and the like.

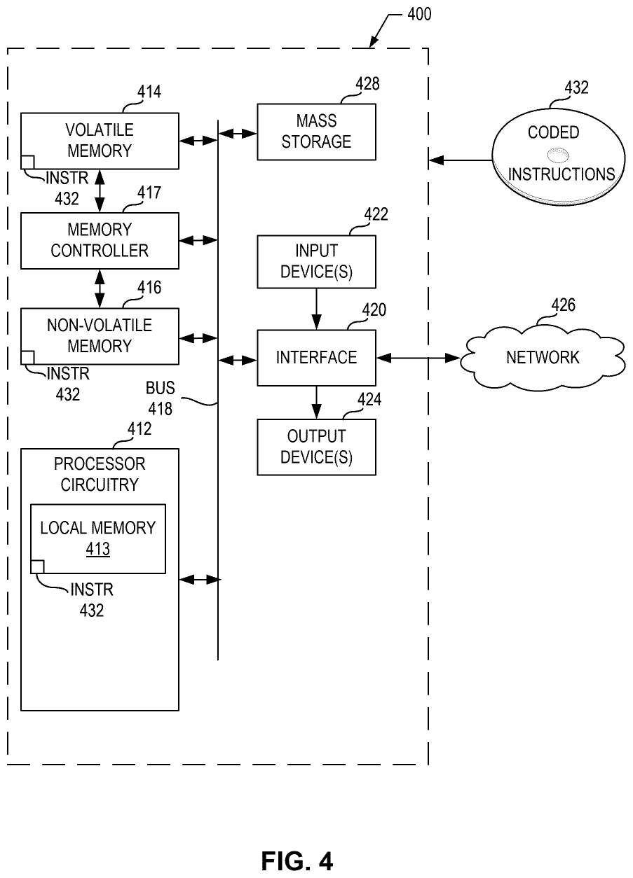

FIG. 4 is a block diagram of an example programmable circuitry platform 400 structured to execute and/or instantiate the example machine-readable instructions and/or the example operations of FIG. 2. The programmable circuitry platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, VPUs, DSPs, and/or microcontrollers from any desired family or manufacturer. The programmable circuitry 412 may be implemented by one or more semiconductor based (e.g., silicon based) devices. In this example, the programmable circuitry 412 implements the control device 42.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 432, which may be implemented by the machine readable instructions of FIG. 2, may be stored in the mass storage device 428, in the volatile memory 414, in the non-volatile memory 416, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

From the foregoing, it will be appreciated that example systems, apparatus, articles of manufacture, and methods have been disclosed that enable operation of a vehicle with an electronic steering system. Disclosed systems, apparatus, articles of manufacture, and methods are accordingly directed to one or more improvement(s) in the operation of a machine such as a computer or other electronic and/or mechanical device.

It is noted that this patent claims priority from patent application Ser. No. 102024110821.5, which was filed on Apr. 17, 2024, and is hereby incorporated by reference in its entirety.
Example 1 includes a method for operating a vehicle with an electronic steering system including controlling a road wheel actuator based on a steering wheel angle of a steering wheel operably coupled to a steering wheel actuator so that a steerable road wheel has a road wheel angle based on the steering wheel angle and a transfer function that relates the road wheel angle to the steering wheel angle, detecting a self-steering fault of the steering wheel actuator, and based on the self-steering fault estimating a steering wheel angle error and performing at least one compensatory measure so that a wheel angle error of the steerable road wheel is reduced.
Example 2 includes the method of example 1, wherein the at least one compensatory measure includes at least a determination of a road wheel angle error based on the steering wheel angle error.
Example 3 includes the method of example 1, wherein estimating the road wheel angle error is further based on the transfer function or an operating point of the transfer function.
Example 4 includes the method of example 1, wherein estimating the steering wheel angle error is further based on a diagnostic timer interval, wherein the diagnostic time interval is predefined and constant, is determined based on a steering wheel speed of the steering wheel being zero at a diagnostic time of the diagnostic time interval, is determined based on a continuously averaged steering wheel speed before a start of the diagnostic time interval, or is determined based on a steering wheel speed difference of the steering wheel between a diagnostic time and a diagnostic end time of the diagnostic time interval, where the steering wheel speed difference is determined based on a non-linear function, is determined based on a maximum torque that can be applied from the steering wheel actuator to the steering wheel or is determined based on a history of detected steering wheel angle values or a history of torque values of the steering wheel actuator.
Example 5 includes the method of example 1, wherein the at least one compensatory measure includes a change in a gear ratio.
Example 6 includes the method of example 5, wherein an offset angle of the road wheel angle is reduced in response to the change in the gear ratio.
Example 7 includes the method of example 1, wherein the at least one compensatory measure includes filtering a steering wheel input.
Example 8 includes the method of example 7, wherein the filtering includes a low-pass filtering of the steering wheel angle.
Example 9 includes the method of example 1, wherein the at least one compensatory measure includes an application of a counter-torque to the steering wheel or a component coupled thereto.
Example 10 includes a steering control system including a steering wheel actuator, a steering wheel angle sensor to determine a position of the steering wheel actuator, a road wheel actuator, a road wheel angle sensor to determine a position of the road wheel actuator, and a control device to determine a self-steering fault of the steering wheel actuator based on the position of the steering wheel actuator and the position of the road wheel actuator, determine a steering wheel actuator angle, and implement at least one compensatory measure to reduce the steering wheel actuator angle error.
Example 11 includes the steering control system of example 10, wherein the at least one compensatory measure includes applying a feedback torque to the steering wheel actuator that is greater than a feedback torque before the self-steering fault.
Example 12 includes the steering control system of example 10, wherein the at least one compensatory measure includes dampening a feedback torque of the steering wheel actuator.
Example 13 includes the steering control system of example 10, wherein the at least one compensatory measure includes a determination of a road wheel angle error based on the steering wheel actuator angle error.
Example 14 includes the steering control system of example 10, wherein determining the steering wheel actuator angle error is based on a transfer function or to an operating point of the transfer function.
Example 15 includes the steering control system of example 10, wherein the compensatory measure includes filtering a steering wheel input of a steering wheel coupled to the steering wheel actuator.
Example 16 includes the steering control system of example 15, wherein filtering the steering wheel input includes applying a low pass filter.
Example 17 includes an electronic steering system for a vehicle including a steering wheel actuator, a steering wheel coupled to the steering wheel actuator, a road wheel actuator, a steerable road wheel coupled to the road wheel actuator, and a control device to determine a movement of the steering wheel and in response to the movement reduce a road wheel actuator angle error.
Example 18 includes the electronic steering system of example 17, wherein reducing the road wheel actuator angle error includes filtering a steering wheel input of the steering wheel.
Example 19 includes the electronic steering system of example 18, wherein filtering the steering input includes applying a low pass filter.
Example 20 includes the electronic steering system of example 17, wherein reducing the road wheel actuator angle error includes applying a feedback torque to the steering wheel actuator that is greater than a feedback torque before the movement.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A method for operating a vehicle with an electronic steering system including:
controlling a road wheel actuator based on a steering wheel angle of a steering wheel operably coupled to a steering wheel actuator so that a steerable road wheel has a road wheel angle based on the steering wheel angle and a transfer function that relates the road wheel angle to the steering wheel angle;
detecting a self-steering fault of the steering wheel actuator; and
based on the self-steering fault:
estimating a steering wheel angle error; and
performing at least one compensatory measure so that a wheel angle error of the steerable road wheel is reduced.

2. The method of claim 1, wherein the at least one compensatory measure includes at least a determination of a road wheel angle error based on the steering wheel angle error.

3. The method of claim 1, wherein estimating the road wheel angle error is further based on the transfer function or an operating point of the transfer function.

4. The method of claim 1, wherein estimating the steering wheel angle error is further based on a diagnostic time interval, wherein the diagnostic time interval:
is predefined and constant;
is determined based on a steering wheel speed of the steering wheel being zero at a diagnostic start time of the diagnostic time interval;
is determined based on a continuously averaged steering wheel speed before a start of the diagnostic time interval; or
is determined based on a steering wheel speed difference of the steering wheel between a diagnostic start time and a diagnostic end time of the diagnostic time interval, where the steering wheel speed difference:
is determined based on a non-linear function;
is determined based on a maximum torque that can be applied from the steering wheel actuator to the steering wheel; or
is determined based on a history of detected steering wheel angle values or a history of torque values of the steering wheel actuator.

5. The method of claim 1, wherein the at least one compensatory measure includes a change in a gear ratio.

6. The method of claim 5, wherein an offset angle of the road wheel angle is reduced in response to the change in the gear ratio.

7. The method of claim 1, wherein the at least one compensatory measure includes filtering a steering wheel input.

8. The method of claim 7, wherein the filtering includes a low-pass filtering of the steering wheel angle.

9. The method of claim 1, wherein the at least one compensatory measure includes an application of a counter-torque to the steering wheel or a component coupled thereto.

10. A steering control system including:
a steering wheel actuator;
a steering wheel angle sensor to determine a position of the steering wheel actuator;
a road wheel actuator;
a road wheel angle sensor to determine a position of the road wheel actuator; and
a control device to:
determine a self-steering fault of the steering wheel actuator based on the position of the steering wheel actuator and the position of the road wheel actuator;
determine a steering wheel actuator angle error; and
implement at least one compensatory measure to reduce the steering wheel actuator angle error.

11. The steering control system of claim 10, wherein the at least one compensatory measure includes applying a feedback torque to the steering wheel actuator that is greater than a feedback torque before the self-steering fault.

12. The steering control system of claim 10, wherein the at least one compensatory measure includes dampening a feedback torque of the steering wheel actuator.

13. The steering control system of claim 10, wherein the at least one compensatory measure includes a determination of a road wheel angle error based on the steering wheel actuator angle error.

14. The steering control system of claim 10, wherein determining the steering wheel actuator angle error is based on a transfer function or to an operating point of the transfer function.

15. The steering control system of claim 10, wherein the compensatory measure includes filtering a steering wheel input of a steering wheel coupled to the steering wheel actuator.

16. The steering control system of claim 15, wherein filtering the steering wheel input includes applying a low-pass filter.

17. An electronic steering system for a vehicle including:
a steering wheel actuator;
a steering wheel coupled to the steering wheel actuator;
a road wheel actuator;
a steerable road wheel coupled to the road wheel actuator; and
a control device to determine a movement of the steering wheel and in response to the movement, reduce a road wheel actuator angle error.

18. The electronic steering system of claim 17, wherein reducing the road wheel actuator angle error includes filtering a steering wheel input of the steering wheel.

19. The electronic steering system of claim 18, wherein filtering the steering wheel input includes applying a low-pass filter.

20. The electronic steering system of claim 17, wherein reducing the road wheel actuator angle error includes applying a feedback torque to the steering wheel actuator that is greater than a feedback torque before the movement.
